(19) United States
(12) Patent Application Publication
(10) Pub. No.: US 2026/0275144 A1
(43) Pub. Date: Sep. 17, 2026

(54) NON-AQUEOUS COATING COMPOSITION COMPRISING POLYSACCHARIDE

(71) Applicant: SWIMC LLC, Cleveland, OH (US)

(72) Inventors: Ingvar LINDH, Bromma (SE); Ronny Yngve LINDELL, Sollentuna (SE)

(21) Appl. No.: 19/469,036

(22) PCT Filed: Apr. 3, 2024
(86) PCT No.: PCT/US2024/022770

§ 371 Date: Sep. 25, 2025

Related U.S. Application Data
(60) Provisional application No. 63/494,474, filed on Apr. 6, 2023.

(51) Int. Cl. C09D 103/14; C09D 7/65

(52) U.S. Cl. CPC C09D 103/14; C09D 7/65

(57) ABSTRACT

Provided herein is a non-aqueous coating comprising: 1) at least one non-aqueous component comprising at least one polymer; and 2) at least one polysaccharide, wherein at least one polymer comprises: polyurethane, polyester, polyether, polyacrylate, alkyd, polyethylene, polypropylene polyvinyl, polystyrene, nylon, polyamine, melamine, polyvinylchloride, and combinations thereof and wherein the non-aqueous coating undergoes curing. At least one polysaccharide of the non-aqueous coating may comprise at least one starch. Also described is an article comprising the non-aqueous coating disclosed herein. Further, a process for preparing the non-aqueous coating is also disclosed.

### FIELD

The present disclosure relates generally to a non-aqueous coating comprising: 1) at least one non-aqueous component comprising at least one polymer; and 2) at least one polysaccharide, wherein at least one polymer comprises: polyurethane, polyester, polyether, polyacrylate, alkyd, polyethylene, polypropylene polyvinyl, polystyrene, nylon, polyamine, melamine, polyvinylchloride, and combinations thereof and wherein the non-aqueous coating undergoes curing. At least one polysaccharide of the non-aqueous coating may comprise at least one starch. An article comprising the non-aqueous coating and a process for preparing the non-aqueous coating are also described.

### BACKGROUND

Conventionally, aqueous systems may use a polysaccharide for rheology properties and stabilization within the formulation. Specifically, polysaccharides may be used for sag resistance, flow and leveling, spatter resistance, hiding, application feel, storage stability, and viscosity. The polysaccharides used are typically chemically modified and soluble within the aqueous system. Further, the use of polysaccharides is well-suited for low volatile organic compound (VOC) paint formulations and airless spray applications, making it a natural and more sustainable alternative.

Although polysaccharides may be widely used in water-based coatings, they are not typically used in solvent-borne and non-aqueous coatings, often due to insolubility. Rather, sol-vent-borne and non-aqueous systems often incorporate materials such as organoclays, hydrogen-ated castor oils, fumed silicas, polyamides, and overbased sulphonates for viscosity properties.

However, some materials used in non-aqueous and solvent-borne coatings may hinder UV curing, particularly inorganic materials. Further, achieving multicoat adhesion remains difficult in non-aqueous and solvent-borne coatings. In view of these challenges with conventional non-aqueous and solvent-borne coatings, the need therefore remains for coatings with improved multicoat adhesion that are able to maintain performance properties as well as other advantages. Further, there is also a need for a method to prepare such coatings with the composition described in non-aqueous and solvent-borne coatings as well as articles with such coatings.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A non-aqueous coating comprising: 1) at least one non-aqueous component comprising at least one polymer; and 2) at least one polysaccharide, wherein at least one polymer comprises: polyurethane, polyester, polyether, polyacrylate, alkyd, polyethylene, polypropylene polyvinyl, poly-styrene, nylon, polyamine, melamine, polyvinylchloride, and combinations thereof and wherein the non-aqueous coating undergoes curing. At least one polysaccharide of the non-aqueous coating may comprise starch, cellulose, hemicellulose, glycogen, or combinations thereof. The starch may comprise potato starch, maize starch, wheat starch, banana starch, shotis starch, rice starch, tapioca starch, sorghum starch, artichoke starch, and combinations thereof. At least one starch may comprise amylose, amylopectin, or combinations thereof.

The non-aqueous coating described herein may be cured by radiation curing. The non-aqueous coating may be cured by ambient curing, heat curing, UV curing, electron beam (EB) curing, LED curing, or combinations thereof.

A process for preparing the non-aqueous coating disclosed herein is also described.

An article is disclosed comprising: 1) a substrate having at least one surface; and 2) the non-aqueous coating described herein which is at least partially coated on the at least one surface of the substrate; wherein the substrate comprises wood, wood composite, metal, plastic, paper, leather, fabric, ceramic, composite, or any combination thereof.

To the accomplishment of the foregoing and related ends, the following description set forth certain illustrative aspects and implementations. These are indicative of but a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings systems, that provide advantageous improvements over current coatings. It has been discovered that a non-aqueous coating comprising at least one polysaccharide, wherein the non-aqueous coating undergoes curing can surprisingly lead to improved adhesion, specifically intercoat adhesion, and substantially maintained performance properties like stability and viscosity over other non-aqueous and solvent-borne coatings, as well as other advantages.

In many embodiments, a non-aqueous coating comprising: 1) at least one non-aqueous component comprising at least one polymer; and 2) at least one polysaccharide, wherein at least one polymer comprises: polyurethane, polyester, polyether, polyacrylate, alkyd, polyethylene, polypropylene polyvinyl, polystyrene, nylon, polyamine, melamine, polyvinylchloride, and combinations thereof and wherein the non-aqueous coating undergoes curing. At least one polysaccharide of the non-aqueous coating may comprise starch, cellulose, hemicellulose, glycogen, or combinations thereof. Specifically, at least one polysaccharide of the non-aqueous coating may comprise starch, cellulose, hemicellulose, glycogen, or combinations thereof. The starch may comprise potato starch, maize starch, wheat starch, banana starch, shotis starch, rice starch, tapioca starch, sorghum starch, artichoke starch, and combinations thereof. At least one starch may comprise amylose, amylopectin, or combinations thereof. Further, at least one starch may comprise amylose, amylopectin, or combinations thereof. In particular, the addition of at least one polysaccharide may provide solids in non-aqueous coatings. Not to be bound by theory, the non-aqueous coating has substantially no water, so the swelling due to the polysaccharides is less than traditional waterborne systems. Additionally, there was substantially no viscosity increase or at least a limited viscosity increase in the non-aqueous coating as would be expected in traditional waterborne systems, which may be due to the decreased swelling in the non-aqueous coating.

Further, the use of polysaccharides may provide a clear coating for the non-aqueous coating. Alternatively, a pigmented coating may be produced using polysaccharides in a non-aqueous coating.

In many embodiments, at least one non-aqueous component comprises at least one polymer, wherein at least one polymer comprises polyurethane, polyester, polyether, polyacrylate, alkyd, polyethylene, polypropylene polyvinyl, polystyrene, nylon, polyamine, melamine, polyvinylchloride, and combinations thereof. In some embodiments, at least one polymer may comprise a polymer derived from natural sources including but not limited to plants. Other non-aqueous polymers are also contemplated.

In some embodiments, at least one non-aqueous component further comprises a (meth)acrylate monomer such as glycerol (meth)acrylate, propoxylated glycerol (meth)acrylate, ethoxylated glycerol (meth)acrylate, hexanediol di(meth)acrylate, hydroxypropyl (meth)acrylate, isobornyl (meth)acrylate, lauryl (meth)acrylate, pentaerythritol tri(meth)acrylate, propoxylated neopentyl glycol di(meth)acrylate, ethoxylated pentaerythritol tetra(meth)acrylate, or combinations thereof. Other monomers are also contemplated. In other embodiments, at least one non-aqueous component further comprises an oligomer from chemical groups of epoxies, esters, ethers, alkyd, ethylene, propylene vinyl, styrene, nylon, amine, melamine, vinylchloride and urethanes, or combinations thereof. Other oligomers are also contemplated.

In many embodiments, at least one non-aqueous component comprising at least one polymer ranges from 0.1% to 60% by weight of the non-aqueous coating. In other embodiments, at least one non-aqueous component comprising at least one polymer of the non-aqueous coating described herein can, for example range from 0.1% to 55% by weight, from 0.1% to 50% by weight, from 0.1% to 45% by weight, from 0.1% to 40% by weight, from 0.1% to 35% by weight, from 0.1% to 30% by weight, from 0.1% to 20% by weight, from 0.1% to 18% by weight, from 0.1% to 15% by weight, from 0.1% to 10% by weight, from 0.5% to 60% by weight, from 0.5% to 55% by weight, from 0.5% to 50% by weight, from 0.5% to 45% by weight, from 0.5% to 40% by weight, from 0.5% to 35% by weight, from 0.5% to 30% by weight, from 0.5% to 25% by weight, from 0.5% to 20% by weight, from 0.5% to 15% by weight, from 0.5% to 13% by weight, from 0.5% to 10% by weight, from 0.5% to 8% by weight, from 0.5% to 7% by weight, from 0.5% to 5% by weight, from 1% to 60% by weight, from 1% to 55% by weight, from 1% to 50% by weight, from 1% to 45% by weight, from 1% to 40% by weight, from 1% to 35% by weight, from 1% to 30% by weight, from 1% to 25% by weight, from 1% to 20% by weight, from 1% to 15% by weight, from 1% to 13% by weight, from 1% to 10% by weight, from 1% to 8% by weight, from 1% to 7% by weight, from 1% to 5% by weight, from 2% to 60% by weight, from 2% to 55% by weight, from 2% to 50% by weight, from 2% to 45% by weight, from 2% to 40% by weight, from 2% to 35% by weight, from 2% to 30% by weight, from 2% to 25% by weight, from 2% to 20% by weight, range from 2% to 18% by weight, from 2% to 15% by weight, from 2% to 13% by weight, from 2% to 10% by weight, from 2% to 8% by weight, from 2% to 7% by weight, from 2% to 5% by weight, from 5% to 60% by weight, from 5% to 55% by weight, from 5% to 50% by weight, from 5% to 45% by weight, from 5% to 40% by weight, from 5% to 35% by weight, from 5% to 30% by weight, from 5% to 25% by weight, from 5% to 20% by weight, from 5% to 15% by weight, from 5% to 13% by weight, from 5% to 10% by weight, from 5% to 8% by weight, from 5% to 7% by weight, from 10% to 60% by weight, from 10% to 55% by weight, from 10% to 50% by weight, from 10% to 45% by weight, from 10% to 40% by weight, from 10% to 35% by weight, from 10% to 30% by weight, from 10% to 25% by weight, from 10% to 20% by weight, from 10% to 15% by weight, from 15% to 60% by weight, from 15% to 55% by weight, from 15% to 50% by weight, from 15% to 45% by weight, from 15% to 40% by weight, from 15% to 35% by weight, from 15% to 30% by weight, from 15% to 25% by weight, from 20% to 60% by weight, from 20% to 55% by weight, from 20% to 50% by weight, from 20% to 45% by weight, from 20% to 40% by weight, from 20% to 35% by weight, from 20% to 30% by weight, from 25% to 60% by weight, from 25% to 55% by weight, from 25% to 50% by weight, from 25% to 45% by weight, from 25% to 40% by weight, from 25% to 35% by weight, and from 25% to 30% by weight. Other weight ranges are also contemplated.

In many embodiments, at least one starch comprises potato starch, maize starch, wheat starch, banana starch, shotis starch, rice starch, tapioca starch, sorghum starch, artichoke starch, and combinations thereof. Other types of starch are also contemplated.

Further, in many embodiments, at least one starch may have a particle size up to 150 μm. In other embodiments, at least one starch of the non-aqueous coating described herein can, for example, have a particle size up to 145 μm, up to 140 μm, up to 135 μm, up to 130 μm, up to 125 μm, up to 120 μm, up to 115 μm, up to 110 μm, up to 105 μm, up to 100 μm, up to 95 μm, up to 90 μm, up to 85 μm, up to 80 μm, up to 75 μm, up to 70 μm, up to 65 μm, up to 60 μm, up to 55 μm, up to 50 μm, up to 45 μm, up to 40 μm, up to 35 μm, up to 30 μm, up to 25 μm, up to 20 μm, up to 15 μm, up to 10 μm, up to 5 μm. For the starch in the non-aqueous coating, using a particle size up to 150 μm may not affect or substantially affect the full cure of the coating even though other types of fillers may prevent a coating from achieving a full cure by preventing the cure method, e.g. UV light, electron beam (EB) curing, LED curing, or combinations thereof, from penetrating through the entire coating.

In many embodiments, at least one starch has a particle size ranging from 1 μm to 150 μm. In some embodiments, the particle size of the starch ranges from 1 μm to 145 μm, from 1 μm to 140 μm, from 1 μm to 135 μm, from 1 μm to 130 μm, from 1 μm to 125 μm, from 1 μm to 120 μm, from 1 μm to 115 μm, from 1 μm to 110 μm, from 1 μm to 105 μm, from 1 μm to 100 μm, from 1 μm to 95 μm, from 1 μm to 90 μm, from 1 μm to 85 μm, from 1 μm to 80 μm, from 1 μm to 75 μm, from 1 μm to 70 μm, from 1 μm to 65 μm, from 1 μm to 60 μm, from 1 μm to 55 μm, from 1 μm to 50 μm, from 1 μm to 45 μm, from 1 μm to 45 μm, for example, from 1 μm to 40 μm, from 1 μm to 35 μm, from 1 μm to 30 μm, from 5 μm to 150 μm, 5 μm to 145 μm, from 5 μm to 140 μm, from 5 μm to 135 μm, from 5 μm to 130 μm, from 5 μm to 125 μm, from 5 μm to 120 μm, from 5 μm to 115 μm, from 5 μm to 110 μm, from 5 μm to 105 μm, from 5 μm to 100 μm, from 5 μm to 95 μm, from 5 μm to 90 μm, from 5 μm to 85 μm, from 5 μm to 80 μm, from 5 μm to 75 μm, from 5 μm to 70 μm, from 5 μm to 65 μm, from 5 μm to 60 μm, from 5 μm to 55 μm, from 5 μm to 50 μm, from 5 μm to 45 μm, from 5 μm to 40 μm, from 5 μm to 35 μm, from 5 μm to 30 μm, from 5 μm to 25 μm, from 10 μm to 150 μm, from 10 μm to 140 μm, from 10 μm to 130 μm, from 10 μm to 125 μm, from 10 μm to 110 μm, from 10 μm to 100 μm, from 10 μm to 75 μm, from 10 μm to 50 μm, from 10 μm to 45 μm, from 10 μm to 40 μm, from 10 μm to 35 μm, from 10 μm to 30 μm, from 10 μm to 25 μm, from 15 μm to 150 μm, from 15 μm to 140 μm, from 15 μm to 130 μm, from 15 μm to 125 μm, from 15 μm to 110 μm, from 15 μm to 100 μm, from 15 μm to 75 μm, from 15 μm to 50 μm, from 15 μm to 45 μm, from 15 μm to 40 μm, from 15 μm to 35 μm, from 15 μm to 30 μm, from 15 μm to 25 μm, from 20 μm to 150 μm, from 20 μm to 140 μm, from 20 μm to 130 μm, from 20 μm to 125 μm, from 20 μm to 110 μm, from 20 μm to 100 μm, from 20 μm to 75 μm, from 20 μm to 50 μm, from 20 μm to 45 μm, from 20 μm to 40 μm, from 20 μm to 35 μm, from 20 μm to 30 μm, from 25 μm to 150 μm, from 25 μm to 140 μm, from 25 μm to 130 μm, from 25 μm to 125 μm, from 25 μm to 110 μm, from 25 μm to 100 μm, from 25 μm to 75 μm, from 25 μm to 50 μm, from 25 μm to 45 μm, from 25 μm to 40 μm, from 25 μm to 35 μm, from 30 μm to 150 μm, from 30 μm to 140 μm, from 30 μm to 130 μm, from 30 μm to 125 μm, from 30 μm to 110 μm, from 30 μm to 100 μm, from 30 μm to 75 μm, from 30 μm to 50 μm, from 30 μm to 45 μm, and from 30 μm to 40 μm, from 50 μm to 150 μm, from 50 μm to 140 μm, from 50 μm to 130 μm, from 50 μm to 125 μm, from 50 μm to 110 μm, from 50 μm to 100 μm, from 50 μm to 75 μm, from 75 μm to 150 μm, from 75 μm to 125 μm, from 75 μm to 100 μm, and from 75 μm to 90 μm. In many embodiments, the particle size of the starch may be less than 150 μm. In some embodiments, the particle size of the starch may be less than 145 μm, for example, less than 140 μm, less than 135 μm, less than 130 μm, less than 125 μm, less than 100 μm, less than 90 μm, less than 75 μm, less than 50 μm, less than 40 μm, less than 35 μm, less than 30 μm, less than 50 μm, less than 25 μm, less than 20 μm, less than 15 μm, less than 10 μm, less than 5, less than 3 μm, and less than 2 μm. In other embodiments, the starch may be nanoparticle size.

In many embodiments, at least one starch of the non-aqueous coating described herein ranges from 0.5% to 40% by weight. In other embodiments, at least one starch of the non-aqueous coating described herein can, for example range from 0.5% to 35% by weight, from 0.5% to 30% by weight, from 0.5% to 25% by weight, from 0.5% to 20% by weight, from 0.5% to 15% by weight, from 0.5% to 13% by weight, from 0.5% to 10% by weight, from 0.5% to 8% by weight, from 0.5% to 7% by weight, from 0.5% to 5% by weight, from 1% to 40% by weight, from 1% to 35% by weight, from 1% to 30% by weight, from 1% to 25% by weight, from 1% to 20% by weight, from 1% to 15% by weight, range from 1% to 13% by weight, from 1% to 10% by weight, from 1% to 8% by weight, from 1% to 7% by weight, from 1% to 5% by weight, from 2% to 40% by weight, from 2% to 35% by weight, from 2% to 30% by weight, from 2% to 25% by weight, from 2% to 20% by weight, from 2% to 15% by weight, from 2% to 13% by weight, from 2% to 10% by weight, from 2% to 8% by weight, from 2% to 7% by weight, from 2% to 5% by weight, from 3% to 40% by weight, from 3% to 35% by weight, from 3% to 30% by weight, from 3% to 25% by weight, from 3% to 20% by weight, from 3% to 15% by weight, from 3% to 13% by weight, from 3% to 10% by weight, from 3% to 8% by weight, from 3% to 7% by weight, from 3% to 5% by weight, from 3% to 15% by weight, from 3% to 13% by weight, from 3% to 10% by weight, from 3% to 8% by weight, from 3% to 7% by weight, from 3% to 5% by weight, from 5% to 40% by weight, from 5% to 35% by weight, from 5% to 30% by weight, from 5% to 25% by weight, from 5% to 20% by weight, from 5% to 15% by weight, from 5% to 13% by weight, from 5% to 10% by weight, from 5% to 8% by weight, from 5% to 7% by weight, from 10% to 40% by weight, from 10% to 35% by weight, from 10% to 30% by weight, from 10% to 25% by weight, from 10% to 20% by weight, from 10% to 15% by weight, from 10% to 13% by weight, from 20% to 40% by weight, from 20% to 35% by weight, from 20% to 30% by weight, from 20% to 25% by weight, from 25% to 40% by weight, from 25% to 35% by weight, from 25% to 30% by weight, from 30% to 40% by weight, and from 30% to 35% by weight. Other weight ranges are also contemplated.

In many embodiments, at least one polysaccharide comprises a homoglycan. For a homoglycan, the polysaccharide contains only one type of monosaccharide. In one embodiment, the homoglycan is a starch. In another embodiment, the homoglycan is a cellulose. Other types of homoglycans are contemplated.

Starch consists of glucose molecules which can occur in two forms: amylose and amylopectin. Amylose is a linear or straight-line polymer that can be amorphous or solid. Amylopectin forms a branched chain and is crystalline. In many embodiments, at least one starch comprises amylose, amylopectin, or combinations thereof. In some embodiments, the amylose ranges from 15% to 30% by weight of the starch. In other embodiments, the amylose of at least one starch of the non-aqueous coating described herein can, for example range from 15% to 28% by weight, from 15% to 25% by weight, from 15% to 23% by weight, from 15% to 20% by weight, from 17% to 30% by weight, from 17% to 28% by weight, from 17% to 25% by weight, from 17% to 23% by weight, from 20% to 30% by weight, from 20% to 28% by weight, from 20% to 25% by weight, from 22% to 30% by weight, from 22% to 28% by weight, and from 22% to 25% by weight. Other weight ranges are also contemplated.

In many embodiments, the curing of the non-aqueous coating comprises radiation curing. In some embodiments, the curing of the non-aqueous coating comprises ambient curing, heat curing, UV curing, electron beam (EB) curing, LED curing, or combinations thereof. Other curing methods are also contemplated.

In some embodiments, the non-aqueous coating described herein is a one-component system. In other embodiments, the non-aqueous coating described herein is a two-component system.

In many embodiments, the non-aqueous coating described herein further comprises at least one: oligomer, monomer, binder, resin, thickener, defoamer, surfactant, dispersant, solvent, initiator, pigment, extender, antimicrobial agent, wax, UV absorber, scavenger, fire retardant, catalyst, crosslinker, synergist, photoinitiator, stabilizer, surface active additives, matting agent, rheology modifier, defoamer, or combinations thereof. Other additives are also contemplated.

In some embodiments, the non-aqueous coating described herein is acid catalyzed. As used herein, the term “acid catalyzed” may also be referred to as acid cured. This acid catalyst, or salt thereof, in the coating composition may catalyze the condensation reaction such that high molecular weight polymers are produced in reasonable reaction times. For example, acid catalysts may help the reaction between the binder, e.g., a hydroxyl binder, and an amine-containing com-pound, e.g., an aminoplast.

In many embodiments, a process for preparing the non-aqueous coating composition described herein is also provided. The non-aqueous coating comprises: 1) at least one non-aqueous component comprising at least one polymer; and 2) at least one polysaccharide; wherein at least one polymer comprises: polyurethane, polyester, polyether, polyacrylate, alkyd, polyethylene, poly-propylene polyvinyl, polystyrene, nylon, polyamine, melamine, polyvinylchloride, and combinations thereof and wherein the non-aqueous coating undergoes curing. In many embodiments, at least one polysaccharide comprises starch, cellulose, hemicellulose, glycogen, or combinations thereof. In some embodiments, at least one starch comprises potato starch, maize starch, wheat starch, banana starch, shotis starch, rice starch, tapioca starch, sorghum starch, artichoke starch, and combinations thereof. In many embodiments, the curing comprises ambient curing, heat curing, UV curing, electron beam (EB) curing, LED curing, or combinations thereof.

In many embodiments, an article comprising: 1) a substrate having at least one surface; and 2) the non-aqueous coating described herein at least partially disposed on the at least one surface of the substrate. In many embodiments, the substrate comprises wood, wood composite, metal, plastic, paper, leather, fabric, ceramic, composite, or any combination thereof. In some embodiments, the wood comprises pine, birch, beech, acacia, oak, walnut, or combinations thereof. In some embodiments, the substrate may be a wood composite. In many embodiments, the wood composite is MDF, HDF, THDF, Particle board, Plywood, and combinations thereof. Other wood species and wood composites are also contemplated.

### Test Results

As provided below in Table 1, a reference formula (identified as Reference Formula 1) containing inorganic calcium carbonate filler is replaced by various levels of starch as shown in Test formulas 1A, 1B, and 1C, while all other materials in the formulation remain constant.

TABLE 1
Test in on non-aqueous UV curable formulation.

| | | Test | Test | Test |
|---|---|---|---|---|
| | Reference | formula | formula | formula |
| | formula 1 | 1A | 1B | 1C |
| Calcium | 42 | 32 | 21 | 0 |
| Carbonate (%) | | | | |
| Polysaccharide: | 0 | 10 | 21 | 42 |
| Starch (%) | | | | |
| Grind grade | 25 my | 80 my | 90 my | 90 my |
| | | upper | upper | upper |
| | | grain | grain | grain |
| Full surface | 524 | 524 | 524 | 524 |
| cure, mJ/cm2 | | | | |
| (Hg-lamp) | | | | |
| Through cure | Pass | Pass | Pass | Pass |
| (Hg-lamp) | | | | |
| Viscosity, | 23 415 | 16 098 | 7 536 | 10 963 |
| 23° C. | | | | |
| mPas | | | | |

All formulas shown in Table 1 are mixed in the same dissolver and at the same speed (1700 rpm) for 30 minutes. Samples of each formula are unfiltered before testing. For the grind grade measurement, ASTM D1210 with Hegman-type gage was used with a visual inspection of particle size. For the surface cure test, a film draw down with applicator on a plain white sealed Leneta card was prepared and then curing with several passes with a low dose under a Hg lamp with curing tested with scraping a wooden stick on the film. The coating was considered to be fully cured when no marks appear when scraping on the surface of the film. For the through cure testing, a film draw down with applicator was completed on a plain white sealed Leneta card followed by curing with several passes under a Hg lamp a low dose and then curing tested with wooden stick. The coating was considered to be through cured when no delamination appears from the substrate. For viscosity testing, the coating was measured with a Brookfield Laboratory Viscosimeter using Spindle 6 at 100 RPM.

The non-aqueous coating described herein is also shown below in Table 2 in comparison to coatings without at least one polysaccharide, namely starch for the samples shown below.

TABLE 2
Comparison in a non-aqueous coating (100% UV) formulation with an inorganic filler and 2 different
particle sizes for starch at two different levels, 5% by weight and 10% by weight.

| | STD Ref. | Filler Ref. | Sample | Sample | Filler Ref. | Sample | Sample |
|---|---|---|---|---|---|---|---|
| Particle d50 | — | 11 μm | 21 μm | 43 μm | 11 μm | 21 μm | 43 μm |
| Filler | No filler | Al₂KNaO₈Si₂ | Starch | Starch | Al₂KnaO₈Si₂ | Starch | Starch |
| | | 5% | 5% | 5% | 10% | 10% | 10% |
| Viscosity mPas | 650 | 600 | 650 | 630 | 806 | 650 | 650 |
| (Brookfield | | | | | | | |
| viscosity with #6 | | | | | | | |
| spindle at 100 rpm) | | | | | | | |
| Curing Hg. 20 m/ | | | | | | | |
| min Dose | | | | | | | |
| 24 μm mJ/cm² | 220 | 220 | 220 | 220 | 220 | 220 | 220 |
| 40 μm mJ/cm2 | 220 | 220 | 220 | 220 | 220 | 220 | 220 |
| Visual appearance | Clear | Clear | Some | Some | Almost | Almost | Almost |
| of film | | | haziness. | haziness. | clear | clear | clear |
| Surface inspection | Smooth | Smooth | Particles | Larger | Smooth | Particles | Larger |
| | | | | particles | | | particles |

With respect to the samples in Table 2, all formulas are mixed in the same dissolver and at the same speed (1700 rpm) for 30 minutes. Samples are unfiltered before testing. For viscosity testing, all test samples are measured with a Brookfield Laboratory Viscosimeter using Spindle 6 at 100 RPM. In the curing test, a film draw down is done with an applicator on a Leneta card, with sub-sequent curing with several passes with a low dose under a Hg lamp, and then curing tested with scraping a wooden stick on the film. The samples are considered to be “cured” when no marks appear when scraping on the surface. For any visual appearance testing, a visual inspection on the clarity in the film is done with both a white and black background. For surface inspection testing, a visual inspection is done on the surface to check for imperfections or inhomogeneous appearance. Based on the results obtained from Table 2, the curing dose of UV light for both deep cure and surface cure (both 24 and 40 mJ/cm2) was consistent between the standard reference coating (labeled Std. Ref. with no filler) and those containing various levels of starch. The standard reference and samples with starch were also compared to samples containing nepheline syenite (Al₂KNaO₈Si₂). For opacity and clarity, the haziness seen in some of the starch samples, but it may be due to the lower gloss of the samples. The viscosity for the starch samples and standard reference coating were similar at lower loadings, but the viscosity may be lower using higher levels of starch, which may be seen in Table 2. This is a surprising and unexpectedly positive effect.

For Table 3 below, a kaolin clay replacement was done using at least one polysaccharide. For the examples below, starch was the polysaccharide tested.

TABLE 3
Starch replacing Kaolin clay in a water containing formulation.

| | Starch | | | Gloss at | |
|---|---|---|---|---|---|
| Kaolin clay | (% by | Viscosity | Coverage^{b} | 60° on | |
| (% by weight) | weight) | (s)^{a} | (%) | glass^{c} | Drying^{d} |
| 21 | 0 | Foamy, | 97 | 3-4 | Acceptable |
| | | data n/a | | | |
| 17 | 4 | Foamy, | 97 | 3-4 | Acceptable |
| | | data n/a | | | |
| 11 | 10 | Foamy, | 94 | 3-4 | Acceptable |
| | | data n/a | | | |
| 0 | 21 | 20 | 86 | 3-4 | Acceptable |

Short description test methods in Table 3:
^{a}Measure viscosity with DIN 4 at 23° C. one day after production.
^{b}Measure color coverage of white pigment with applicator of 100 μm on Leneta cards.
^{c}Measure gloss on the glass surface by gloss meter after cure in 50° C. oven after 15 minutes.
^{d}Cure in 50° C. oven for 15 minutes, then evaluate the surface by scraping a wooden stick on the film. The sample is considered to be cured when no marks appear on the surface of the film.

Although viscosity was not measurable at the lower levels of starch in Table 3 (de-scribed as foamy and data not available (n/a)), starch provided a positive defoaming effect for the coating formulation at a higher level. By using the starch, foam was reduced and a viscosity could be measured. Further, higher levels of starch slightly decreased the covering effect but no notice-able effect on gloss or drying was observed.

### EMBODIMENTS

The following embodiments are contemplated. All combinations of features and embodiments are contemplated.

Embodiment 1: A non-aqueous coating comprising: 1) at least one non-aqueous com-ponent comprising at least one polymer; and 2) at least one polysaccharide; wherein at least one polymer comprises: polyurethane, polyester, polyether, polyacrylate, alkyd, polyethylene, polypropylene polyvinyl, polystyrene, nylon, polyamine, melamine, polyvinylchloride, and combinations thereof and wherein the non-aqueous coating undergoes curing.

Embodiment 2: An embodiment of Embodiment 1, wherein the at least one non-aqueous component comprises at least one monomer, at least one oligomer, or combinations thereof.

Embodiment 3: An embodiment of any of Embodiments 1-2, wherein the at least one non-aqueous component ranges from 0.1% to 60% by weight of the non-aqueous coating.

Embodiment 4: An embodiment of any of Embodiments 1-3, wherein the at least one polysaccharide comprises starch, cellulose, hemicellulose, glycogen, or combinations thereof.

Embodiment 5: An embodiment of Embodiment 4, wherein the at least one starch comprises potato starch, maize starch, wheat starch, banana starch, shotis starch, rice starch, tapioca starch, sorghum starch, artichoke starch, and combinations thereof.

Embodiment 6: An embodiment of any of Embodiments 4-5, wherein the at least one starch ranges from 0.5% to 40% by weight.

Embodiment 7: An embodiment of any of Embodiments 4-6, wherein the at least one starch has a particle size ranging from 1 μm to 150 μm.

Embodiment 8: An embodiment of any of Embodiments 4-7, wherein the at least one polysaccharide comprises a homoglycan.

Embodiment 9: An embodiment of any of Embodiments 4-8, wherein the at least one starch comprises amylose, amylopectin, or combinations thereof.

Embodiment 10: An embodiment of Embodiment 9, wherein the amylose ranges from 15% to 30% by weight of the starch.

Embodiment 11: An embodiment of any of Embodiments 1-10, wherein the curing comprises radiation curing.

Embodiment 12: An embodiment of any of Embodiments 1-10, wherein the curing comprises ambient curing, heat curing, UV curing, electron beam (EB) curing, LED curing, or combinations thereof.

Embodiment 13: An embodiment of any of Embodiments 1-12, wherein the non-aqueous coating is a one-component system.

Embodiment 14: An embodiment of any of Embodiments 1-12, wherein the non-aqueous coating is a two-component system.

Embodiment 15: An embodiment of any of Embodiments 1-14 further comprising at least one: binder, resin, thickener, defoamer, surfactant, dispersant, solvent, pigment, extender, antimicrobial agent, wax, UV absorber, scavenger, fire retardant, crosslinker, synergist, photointiator, or combinations thereof.

Embodiment 16: An embodiment of any of Embodiments 1-15, wherein the non-aqueous coating is acid catalyzed.

Embodiment 17: A process for preparing the non-aqueous coating of any of Embodiments 1-16.

Embodiment 18: An article comprising: 1) a substrate having at least one surface; and 2) the non-aqueous coating of any of Embodiments 1-16 at least partially coated on the at least one surface of the substrate; wherein the substrate comprises wood, wood composite, metal, plastic, paper, leather, fabric, ceramic, composite, or any combination thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-aqueous coating comprising:
at least one non-aqueous component comprising at least one polymer; and
at least one polysaccharide;
wherein at least one polymer comprises: polyurethane, polyester, polyether, polyacrylate, alkyd, polyethylene, polypropylene polyvinyl, polystyrene, nylon, polyamine, melamine, polyvinylchloride, and combinations thereof;
wherein the non-aqueous coating undergoes curing.

2. The non-aqueous coating of claim 1, further comprising at least one non-aqueous component comprising at least one monomer, at least one oligomer, or combinations thereof.

3. The non-aqueous coating of claim 1, wherein the at least one non-aqueous component ranges from 0.1% to 60% by weight of the non-aqueous coating.

4. The non-aqueous coating of claim 1,
wherein the at least one polysaccharide comprises starch, cellulose, hemicellulose, glycogen, or combinations thereof.

5. The non-aqueous coating of claim 4, wherein the at least one starch comprises potato starch, maize starch, wheat starch, banana starch, shotis starch, rice starch, tapioca starch, sorghum starch, artichoke starch, and combinations thereof.

6. The non-aqueous coating of claim 4, wherein the at least one starch ranges from 0.5% to 40% by weight.

7. The non-aqueous coating of claim 4, wherein the at least one starch has a particle size ranging from 1 μm to 150 μm.

8. The non-aqueous coating of claim 4, wherein the at least one polysaccharide comprises a homoglycan.

9. The non-aqueous coating of claim 4, wherein the at least one starch comprises amylose, amylopectin, or combinations thereof.

10. The non-aqueous coating of claim 9, wherein the amylose ranges from 15% to 30% by weight of the starch.

11. The non-aqueous coating of claim 1, wherein the curing comprises radiation curing.

12. The non-aqueous coating of claim 1, wherein the curing comprises ambient curing, heat curing, UV curing, electron beam (EB) curing, LED curing, or combinations thereof.

13. The non-aqueous coating of claim 1, wherein the non-aqueous coating is a one-component system.

14. The non-aqueous coating of claim 1, wherein the non-aqueous coating is a two-component system.

15. The non-aqueous coating of claim 1 further comprising at least one: binder, resin, thickener, defoamer, surfactant, dispersant, solvent, pigment, extender, antimicrobial agent, wax, UV absorber, scavenger, fire retardant, crosslinker, synergist, photointiator, or combinations thereof.

16. The non-aqueous coating of claim 1, wherein the non-aqueous coating is acid catalyzed.

17. A process for preparing the non-aqueous coating of claim 1.

18. An article comprising:
a substrate having at least one surface; and
the non-aqueous coating of claim 1 at least partially coated on the at least one surface of the substrate;
wherein the substrate comprises wood, wood composite, metal, plastic, paper, leather, fabric, ceramic, composite, or any combination thereof.
